(19) United States
(12) Patent Application Publication
(10) Pub. No.: US 2012/0255918 A1
(43) Pub. Date: Oct. 11, 2012

(54) USE OF RHAMNOLIPIDS IN THE WATER TREATMENT INDUSTRY

(76) Inventors: Keith DeSanto, Guifport, FL (US); Donald R Keer, Doylestown, PA (US)

(21) Appl. No.: 13/440,052

(22) Filed: Apr. 5, 2012

Related U.S. Application Data
(60) Provisional application No. 61/473,008, filed on Apr. 7, 2011.

(51) Int. Cl. B01D 65/06; C02F 1/44

(52) U.S. Cl. 210/791; 210/321.69; 210/321.64; 210/241

(57) ABSTRACT

The present invention relates to a water treatment system that uses rhamnolipids to prevent fouling and bio-film formation on the membrane and equipment and the method thereof.

### CROSS-REFERENCE TO RELATED APPLICATIONS

This application claims the benefit of priority to U.S. Provisional Application No. 61/473,008 filed Apr. 7, 2011, the contents of which are incorporated herein by reference.

### FIELD OF THE INVENTION

The present invention relates to a water treatment system. More specifically, the present invention relates to the use of rhamnolipids for controlling fouling and bio-film formation on the membrane in water treatment systems.

### BACKGROUND OF THE INVENTION

Filters and membranes are currently being used in water treatment systems including, for example, desalination, brackish water treatment, ultra-high purity water, power generation, and/or wastewater treatment.

Selective membranes are generally used in water treatment filtration systems to separate solutes from the water in which the solutes are dissolved or suspended. Some examples of such membranes are reverse osmosis (RO) membranes, ultrafiltration (UF) membranes, and microfiltration (MF) membranes. During operation, the membranes are susceptible to fouling, bio-film formation, scale formation, and organic coating (hereafter all of them being collectively referred to as foulants), which reduces the water permeability. The foulants are attracted to the membrane surface by hydrophobic interaction and/or charge attraction between the solutes and the membrane surface in addition to colloidal deposits.

Fouling occurs as material deposits on a membrane causing the pores of the membrane to constrict or be clogged. Fouling is quantified by the resistance of a membrane in allowing materials to pass through the barrier. As a membrane fouls, the pressure drops across the membrane increasing the energy required by the pump to pass the fluid through the membrane.

Several chemicals such as NaOH, NaOCl, HCl, and citric acid have been used to clean fouled membranes to maximize the flux recovery. Unfortunately, these chemicals are harmful to humans and the environment, which may limit their use. In addition, when using these chemicals, the effluent must be treated prior to its release from the water treatment plant.

As can be seen, there is a need for providing an easy way to prevent the membrane fouling or bio-film formation and maintain the performance of the water treatment system without harming the environment.

### SUMMARY OF THE INVENTION

In one aspect of the present invention, a method for treating a raw water comprises the step of forming a rhamnolipid stream containing sufficient amounts of rhamnolipid to prevent the formation of a bio-film or fouling on a membrane; and introducing the rhamnolipid stream into a raw water stream that leads to the membrane.

In another aspect of the present invention, a system for treating a raw water comprising a raw water inlet for introducing a raw water stream into the system; a rhamnolipid inlet for introducing a rhamnolipid stream containing rhamnolipids into the system; a membrane module in fluid communication with the raw water stream and the rhamnolipid stream; the rhamnolipid stream contains sufficient amounts of rhamnolipid to prevent the formation of a bio-film or fouling on the membrane module; and the rhamnolipid stream is introduced into the raw water stream prior to entering the membrane module.

These and other features, aspects and advantages of the present invention will become better understood with reference to the following drawings, description and claims.

### BRIEF DESCRIPTION OF THE DRAWING

FIG. 1 shows a front view of a water treatment system according to an exemplary embodiment of the present invention;

FIG. 2 shows a top view of the water treatment system of FIG. 1;

FIG. 3 shows a left side view of the water treatment system of FIG. 1; and

FIG. 4 shows a right side view of the water treatment system of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

As used herein, the term water treatment refers to desalting, seawater separation or desalination, brackish water, pure water industrial production, ultrapure water, industrial wastewater treatment, separation or concentration in the food industry, recovery of valuable materials from wastewater, tertiary sewage water recovery, heavy metals and plating salts concentration, dewatering liquid for reduced disposal volume, dilute materials recovery, radioactive materials recovery, textile waste recovery for reuse, pulp and paper water recovery for reuse, dye and ink concentration and recovery, photographic waste concentration and recovery, oil field “produced water” treatment, lubricants concentration for reuse, commercial laundry water and heat reuse, end of pipe treatment for water recovery, microbial removal, bacteria, pyrogens, giardia and cryptosporidium cysts, THM precursor and pesticide removal, potable from seawater, sodium and organics reduction for beverages, reconstituting food and juices, bottled water, can and bottle rinsing, rinse water for metal finishing operations, spot-free car wash rinses, laboratory and reagent grade water, USP purified water and water for injection, semiconductor chip rinsing, distillation and deionization system pretreatment, kidney dialysis, medical device and packaging rinse water, photographic rinse water, pulp and paper rinses and makeup water, and dye vat makeup water.

As used herein, the term membrane refers to a commercially available filtering membrane, for example, reverse osmosis membranes, ultrafilter membranes, hollow fiber membranes, and microfilter membranes.

As used herein, the term raw water refers to any type of water or waste water which may be treated to improve its quality including ground water, fresh water, brackish water, sea water, or produced water, liquid waste discharged by domestic residences, commercial properties, industry, and/or agriculture.

Broadly, embodiments of the present invention generally provide a water treatment system that uses rhamnolipids to prevent fouling and bio-film formation on the membrane and equipment and the method thereof.

The prior art uses surfactants in the manufacture of soaps, laundry detergents, dishwashing liquids, personal care products, lubricants, emulsion polymerization, textile processing, mining flocculates, and petroleum recovery.

Surfactants are chemicals that reduce the surface tension of water. Surfactants are made up of two parts, a head and a tail, each part having differing properties. The head is hydrophilic (attracted to water) and the tail is hydrophobic (repels water). Because of these characteristics, a surfactant exhibits a unique reaction when in contact with water containing oils, greases and organics, reducing the surface tension between the materials.

In recent years, there has been an increase in the use of bio-surfactants, because they are an environmentally friendly alternative to petroleum-derived surfactants and their potential use in different areas, such as the food industry, agriculture, pharmaceuticals, cosmetic, and oil industries.

Rhamnolipids are organic, biodegradable surfactants that are also biocide. Rhamnolipids are secreted from bacteria and microbes with a naturally occurring extracellular glycolipid that is found in the soil and on plants. Rhamnolipids provide a powerful antibacterial and antifungal activity, and low toxicity levels, which make them an attractive alternative to the known petroleum derived surfactants.

The method and system according to the present invention generally include contacting the raw water stream with a liquid stream including at least one rhamnolipid in sufficient quantities to limit the deposit of foulants and the establishment of bio-films on the membrane surfaces.

After a long period of search and research, the present inventors surprisingly discovery that rhamnolipids effectively prevents the formation of fouling and bio-films on the membranes, control and kill waterborne microorganisms, are compatible with existing membranes, are non-toxic, do not require to stop the process for the cleaning of the membranes in existing water treatment systems, are cost effective, are not harmful to the environment, and comply with regulatory requirements at concentrations that are effective to prevent bio-film formation.

It is important to prevent and/or minimize the generation of fouling and bio-films, to use rhamnolipids in addition to the pretreatment of the water feed, the maintenance of the upstream unit operation, maintenance of a continuous water stream through the membrane, using a sanitization agent, and using preservatives during downtime required for repair.

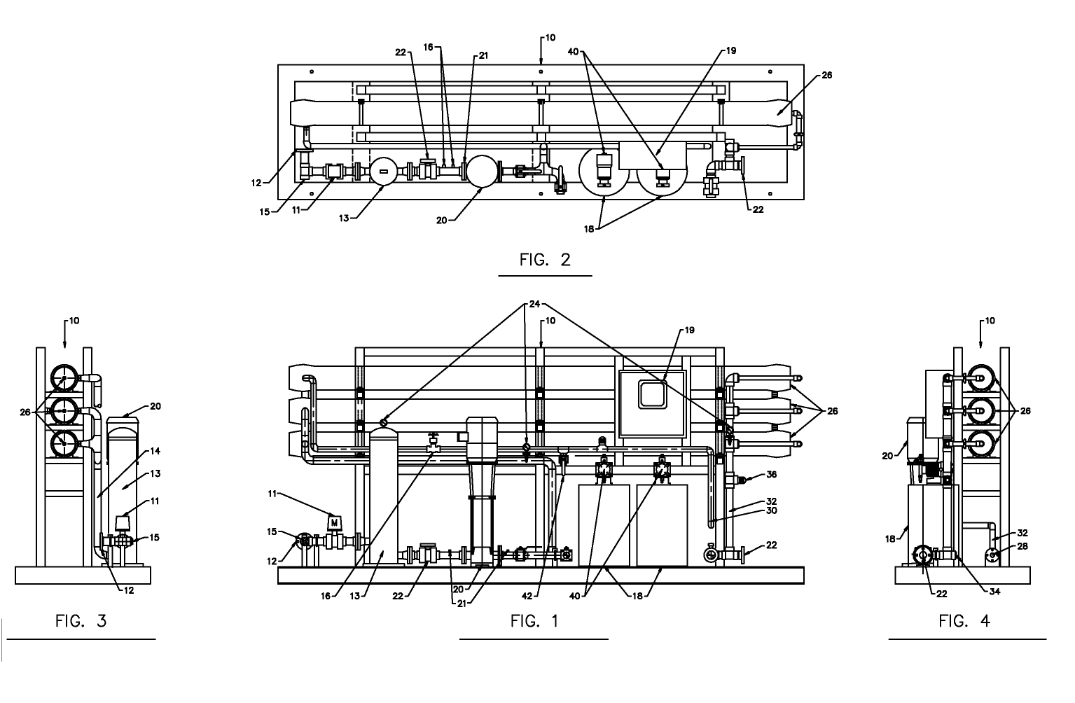

FIGS. 1-4 show a water treatment system 10 according to an exemplary embodiment of the present invention. The water treatment system 10 may be a portable system, an industrial sized system, or a household sized system.

If the water treatment system 10 is a portable system, a casing (not shown) may be included to house all of the components of the water treatment system 10. In addition, wheels may be added to help during the transportation.

The water treatment system 10 may be electronically controlled by a control module 20 to allow for optimum operation. The control module 290 may be a commercially available automated control device.

The water treatment system 10 may include a raw water intake inlet 12 capable of introducing the raw water (not shown) into the water treatment system 10. The amount of raw water entering through the raw water intake inlet 12 may be controlled by a suitable valve 11, for example, an electric actuated ball valve. The valve 11 may limit the raw water stream to the system 10 and prevent the backstream of the raw water at the raw water inlet 12. The size of the raw water inlet 12 may depend on the size of the water treatment system 10. The raw water inlet 12 may have, for example, a diameter of approximately 2.5 inches and may be introduced at a rate of approximately 97 gallons per minute into the water treatment system 10.

The raw water inlet 12 may be in fluid communication with a pipeline 14. The size of the pipeline 14 may depend on the size of the raw water inlet 12. The pipeline may be made of a non-corrosive material, for example, polyvinyl Chloride (PVC).

A conductivity sensor 15 may be mounted on the pipeline 14 and measures the conductivity of the raw water near the raw water inlet 12. The conductivity sensor 15 may be used to measure the total dissolved solids in the raw water.

The pipeline 14 may feed the raw water into a pretreatment device 13 having a backwash line (not shown) connected to a drain line (not shown) for discharge of the filtrate. The pretreatment device 13 may be any type of filter capable of removing particles from the raw water, for example, a coagulation device, a sand filtration device, a polishing filtration device, an active carbon treatment device, microfiltration device. The raw water may pass through the pretreatment device 13 before entering the membrane 19. The pretreatment device 13 may be selected depending on the type of raw water.

The raw water may be caused to stream through the system 10 by an intake pump 20. The intake pump 20 may be located after the pretreatment device 13 and isolation valve 22. The intake pump 20 may be, for example, a centrifugal pump, a multistage centrifugal pump, a positive displacement pump or any other type of pressurizing mechanism that imparts enough drive pressure to pass the water through the membrane.

The isolation valve 22 may be located between the pretreatment device 13 and the intake pump 20. A pressure switch 21 may be placed between the isolation valve 22 and the intake pump 20. The pressure switch 21 may be designed to set the difference in pressure between gauges 24 and if the pressure is excessive, the pressure switch 21 may shut down the system 10 to indicate a need for replacement of the pretreatment device 13.

The raw water leaving the pretreatment device 13 may be mixed with a rhamnolipid stream entering the system 10 from a rhamnolipid inlet 16. The rhamnolipid may be supplied to the system from storage tanks 18. The storage tanks 18 may include stream regulators 40, level regulators (not shown), and a dosing pump (not shown).

The rhamnolipid may be a commercially available rhamnolipid. The rhamnolipid may be, for example, one or more rhamnolipids of formula I:

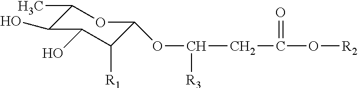

wherein R¹=H, unsubstituted α-L-rhamnopyranosyl, α.-L-rhamnopyranosyl substituted at the 2 position with a group of formula —O—C(═O)—CH═CH—R₅, or —O—C(═O)—CH═CH—R₅;

R²=H, lower alkyl, —CHR₄—CH₂—COOH or —CHR₄—CH₂—COOR₆;

R³=—(CH₂)ₓ—CH₃, wherein x=4-19;

R⁴=—(CH₂)_{y}—CH₃, wherein y=1-19;

R⁵=(CH₂)_{z}—CH₃, wherein z=1-12; and

R⁶=lower alkyl.

Furthermore, the rhamnolipid of formula 1 is α-L-rhamnopyranosyl-(1,2)-α-L-rhamnopyranosyl)-3-hydroxydecanoyl-3-hydroxydecanoic acid having the following formula:

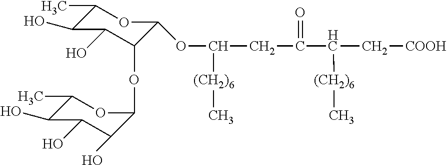

Furthermore, the one or more rhamnolipids of formula 1 are selected from the group consisting of compounds of Formula 1 wherein:

R¹=—O—C(═O)—CH═CH—R₅, R²=—CHR₄—CH₂—COOH, R³=—(CH₂)₆—CH₃, R⁴=—(CH₂)₂—CH₃, and R⁵=—(CH₂)₆—CH₃;

R¹=α-L-rhamnopyranosyl substituted at the 2-position by —O—C(═O)—CH═CH—R⁵, R²=—CHR⁴—CH₂—COOCH₃, R³═(CH₂)₆—CH₃, R⁴=—(CH₂)₆—CH₃, and R⁵=—(CH₂)₆—CH₃;

R¹=—O—C(═O)—CH═CH—R₅, R²=—CHR₄—CH₂—COOCH₃, R³=—(CH₂)₆—CH₃, R⁴=—(CH₂)₂—CH₃, and R⁵=—(CH₂)₆—CH₃; and

R¹=α-L-rhamnopyranosyl substituted at the 2-position by —O—C(═O)—CH═CH—R⁵, R²=—CHR⁴—CH₂—COOCH₃, R³=—(CH₂)₆—CH₃, R⁴=—(CH₂)₆—CH₃, and R⁵=—(CH₂)₆—CH₃.

The rhamnolipid may be a crude or highly purified rhamnolipid. A crude rhamnolipid is a rhamnolipid having many impurities that are external and/or a variety of various rhamnolipid mixtures, which causes a reduced effect on the formulation. Highly purified rhamnolipids is a rhamnolipid whose external impurities have been removed, and/or the rhamnolipids have been purified to meet certain parameters to cause an increased effect on the formulation, which includes di-rhamnolipid, mono-rhamnolipid or combination thereof.

The concentration of rhamnolipids injected into the system 10 may depend on the characteristics of the membrane, the system operating parameters, and the type of raw water.

The rhamnolipid may be introduced:

continuously injected into the stream of raw water in sufficient quantities to limit the deposit of foulants and the establishment of bio-films on membrane surfaces;

continuously injected into the stream of raw water to concentration between approximately 1 ppm and 100 ppm; or

periodically or intermittently injected into a pretreatment tank (not shown) at a designated dosage over a designated volume or time.

After a long investigation, the present inventors discovered that by using rhamnolipids, the effectiveness and operating lifetimes of pressure-driven membrane filtration systems are obtained, by increasing throughput, maintaining or improving efficiency, reducing biofilm, decreasing periodic maintenance requirements, and decreasing the need for costly system shutdowns.

In the illustrated embodiment, three membrane modules 26 are shown. The present invention is not limited by the number of membrane modules 26. The membrane modules 26 may include a permeate outlet 22 and a concentrate outlet 28. Permeate outlets 22 connect to a permeate line 30. Concentrate outlets 28 may be connected to a concentrate line 32 which has the system pressure gauge 24 incorporated thereon.

The permeate line 30 has a conductivity sensor 34 and is then connected to a three-way valve (not shown). The permeate may be fed through a stream meter 36 to the required use of the permeate water and/or to a holding tank arrangement.

The membrane module 26 may be a hollow fiber module, spiral wound module, a membrane cartridge, flat sheet membrane module, ultrafiltration membrane module, UF membrane module, PVDF MBR membrane module, PP MBR membrane module, a hollow fiber membrane module, RO module, and UF membrane module.

In one embodiment, the system 10 includes more than one membrane module 26. In a further embodiment, the membrane modules 26 may be of the same type. In another further embodiment, the membrane modules 26 may be of a different type.

The operational pressure of the membrane module 26 may depend, for example, on the type of raw water and the operation method. The operational pressure of a membrane module 26 may be, for example, between approximately 20 psig and 2,000 psig. The operation temperature of the membrane module 26 may be between 0° C. to 100° C. If the temperature is lower than 0° C., the raw water undergoing treatment may be frozen, and if higher than 100° C., the raw water undergoing treatment may evaporate.

The amount of rhamnolipids entering the membrane module 26 may be controlled by a regulator 42. Inside the membrane module 26, the filtered raw water contacts with the rhamnolipid stream. The contacting of rhamnolipid with the filtered raw water will instantly cause the emulsion of oils and greases, coagulation of colloids, and destruction of bacteria present in the raw water so that the colloids and emulsion may be removed by membranes (not shown) inside the membrane module 26.

The addition of rhamnolipids to the water treatment system 10 may provide a rhamnolipid residual in the permeate 22. Having rhamnolipid residual in the permeate 22 may prevent microbiological recontamination by the downstream piping or storage systems.

To determine the effectiveness of rhamnolipids in destroying and/or preventing fouling and/or bio-film formation, a percent recovery was calculated by dividing the amount of the raw water leaving the membrane module 26 by the amount of the raw water entering the system 10, and multiplying the quotient by 100.

The use of rhamnolipids resulted in a flux percent recovery of 90 to 98%. The flux percent recoveries using NaCl and HCl was 78% and 70% respectively.

As can be seen, the addition of the bio-surfactant may reduce the fouling on surfaces by oils, greases and other organic materials. The reduced fouling may allow the water treatment equipment to operate more efficiently, reducing energy consumption thus creating an economic advantage.

Furthermore, the system 10 provides an easy way to prevent the membrane fouling or bio-film formation and maintain the performance of the system without harming the environment or performing post treatment of the residue leaving the system 10.

The present invention also contemplates a method of adding rhamnolipids to a stream of raw water before entering the membrane module 26.

It should be understood, of course, that the foregoing relates to exemplary embodiments of the invention and that modifications may be made without departing from the spirit and scope of the invention as set forth in the following claims.

What is claimed is:

1. A method for treating a raw water comprising the steps of:
forming a rhamnolipid stream containing sufficient amounts of rhamnolipid to prevent the formation of a bio-film or fouling on a membrane; and
introducing the rhamnolipid stream into a raw water stream that leads to the membrane.

2. The method according to claim 1, wherein the rhamnolipid is introduced into the raw water stream at a concentration of between of 1 ppm and 100 ppm.

3. The method according to claim 1, wherein the rhamnolipid includes one or more rhamnolipids of formula I: 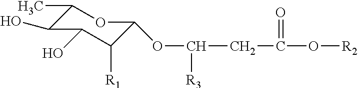
wherein R¹=H, unsubstituted α-L-rhamnopyranosyl, α.-L-rhamnopyranosyl substituted at the 2 position with a group of formula —O—C(═O)—CH═CH—R₅, or —O—C(═O)—CH═CH—R₅;
R²=H, lower alkyl, —CHR₄—CH₂—COOH or —CHR₄—CH₂—COOR₆;
R³=—(CH₂)ₓ—CH₃, wherein x=4-19;
R⁴=—(CH₂)_{y}—CH₃, wherein y=1-19;
R⁵=(CH₂)_{z}—CH₃, wherein z=1-12; and
R⁶=lower alkyl.

4. The method according to claim 3, wherein the rhamnolipid of formula 1 is α-L-rhamnopyranosyl-(1,2)-α-L-rhamnopyranosyl)-3-hydroxydecanoyl-3-hydroxydecanoic acid having the following formula:

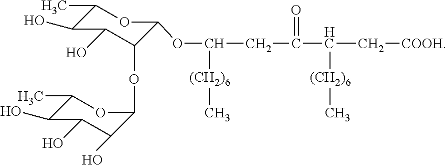

5. The method according to claim 1, wherein the rhamnolipid includes a crude or a highly purified rhamnolipid.

6. The method according to claim 1, wherein the rhamnolipid includes di-rhamnolipid, mono-rhamnolipid or combination thereof.

7. The method according to claim 1, wherein the membrane module includes at least two membranes devices.

8. The method of claim 1, wherein the bio-film and/or fouling formation of the membrane is prevented by contacting the stream of raw water with the stream of rhamnolipid.

9. A system for treating a raw water comprising:
a raw water inlet for introducing a raw water stream into the system;
a rhamnolipid inlet for introducing a rhamnolipid stream containing rhamnolipids into the system;
a membrane module in fluid communication with the raw water stream and the rhamnolipid stream;
wherein the rhamnolipid stream contains a sufficient amount of rhamnolipids to prevent the formation of a bio-film or fouling on the membrane module;
wherein the rhamnolipid stream is introduced into the raw water stream prior to entering the membrane module.

10. The system according to claim 9, further including at least one pretreatment device operatively connected to the raw water inlet.

11. The system according to claim 10, wherein the rhamnolipid is introduced into the raw water stream at a concentration of between of 1 ppm and 100 ppm.

12. The system according to claim 10, wherein the rhamnolipid includes one or more rhamnolipids of formula I: 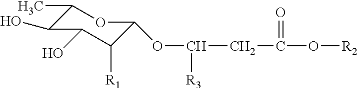
wherein R¹=H, unsubstituted α-L-rhamnopyranosyl, α.-L-rhamnopyranosyl substituted at the 2 position with a group of formula —O—C(═O)—CH═CH—R₅, or —O—C(═O)—CH═CH—R₅;
R²=H, lower alkyl, —CHR₄—CH₂—COOH or —CHR₄—CH₂—COOR₆;
R³=—(CH₂)ₓ—CH₃, wherein x=4-19;
R⁴=—(CH₂)_{y}—CH₃, wherein y=1-19;
R⁵═(CH₂)_{z}—CH₃, wherein z=1-12; and
R⁶=lower alkyl.

13. The system according to claim 12, wherein the rhamnolipid of formula 1 is α-L-rhamnopyranosyl-(1,2)-α-L-rhamnopyranosyl)-3-hydroxydecanoyl-3-hydroxydecanoic acid having the following formula:

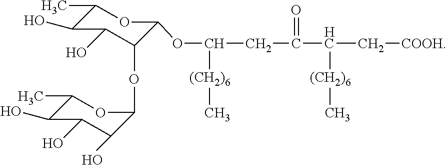

14. The system according to claim 10, wherein the rhamnolipid is a crude or a highly purified rhamnolipid.

15. The system according to claim 10, wherein the rhamnolipid includes di-rhamnolipid, mono-rhamnolipid or combination thereof.

16. The system according to claim 10, wherein the membrane module includes at least two membrane devices.

17. The system according to claim 16, wherein the membrane devices are different.

18. The system according to claim 10, wherein the system is a portable system including wheels.
